(19) United States
(12) Patent Application Publication
(10) Pub. No.: US 2020/0129910 A1
(43) Pub. Date: Apr. 30, 2020

(54) AIR FRESHENING SYSTEM AND DEVICE

(71) Applicant: VERTICAL FIELD LTD., Hod Hasharon (IL)

(72) Inventor: Guy BARNESS, Hod Hasharon (IL)

(21) Appl. No.: 16/494,379

(22) PCT Filed: Mar. 1, 2018
(86) PCT No.: PCT/IL2018/050238

§ 371 Date: Sep. 16, 2019

(30) Foreign Application Priority Data
Mar. 16, 2017 (IL) 251205

(51) Int. Cl. B01D 46/00; A01G 27/00; A01G 29/00

(52) U.S. Cl. CPC B01D 46/0082; A01G 27/001; B01D 2279/50; A01G 29/00; A01G 27/008

(57) ABSTRACT

An air freshening system, including: an air compressor, for flowing air; a water inlet, for supplying water; a central pipe, for receiving the air from the air compressor, and for receiving the water from the water inlet; and a plurality of end devices, each including: a water dripper, including an inlet, for communicating with the central pipe; a filter, for filtering the air; and an outlet, for supplying filtered air, thereby allowing cleaning the filters of the plurality of end devices by supplying the water thereto.

### TECHNICAL FIELD

The invention relates to the field of air freshening systems.

### BACKGROUND

Improved indoor air quality is conventionally obtained either by filtering or by indoor grown plants.

However, filtering requires periodic cleaning of the filter; and plants suffer from bad air quality.

There is a long felt need to provide a solution to the above-mentioned and other problems of the prior art.

### SUMMARY

In one aspect, the invention is directed to an air freshening system (10A), including:
an air compressor (52), for flowing air (70);
a water inlet (48), for supplying water (50);
a central pipe (44), for receiving the air (70) from the air compressor (52), and for receiving the water (50) from the water inlet (48); and
a plurality of end devices (10B), each including:
a) a water dripper (20), including an inlet (24), for communicating with the central pipe (44):
b) a filter (30), for filtering the air (70): and
c) an outlet (42), for supplying filtered air (70B), thereby allowing cleaning the filters (30) of the plurality of end devices (10B) by supplying the water (50) thereto.

### BRIEF DESCRIPTION OF THE DRAWINGS

Embodiments, features, and aspects of the invention are described herein in conjunction with the following drawings:

FIG. 1 depicts an air freshening system according to one embodiment of the invention.

FIG. 2 depicts one of the water drippers of FIG. 1.

FIG. 3 is an exploded view of the water dripper of FIG. 2.

FIG. 4 depicts the air freshening system of FIG. 1, for freshening ground of a plant.

FIG. 5 is an exploded view of the air freshening device of FIG. 4.

FIG. 6 is a cut view of the air freshening device of FIG. 4.

Partitions 68 between adjacent 42 provide physical strength for the tacking operation.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

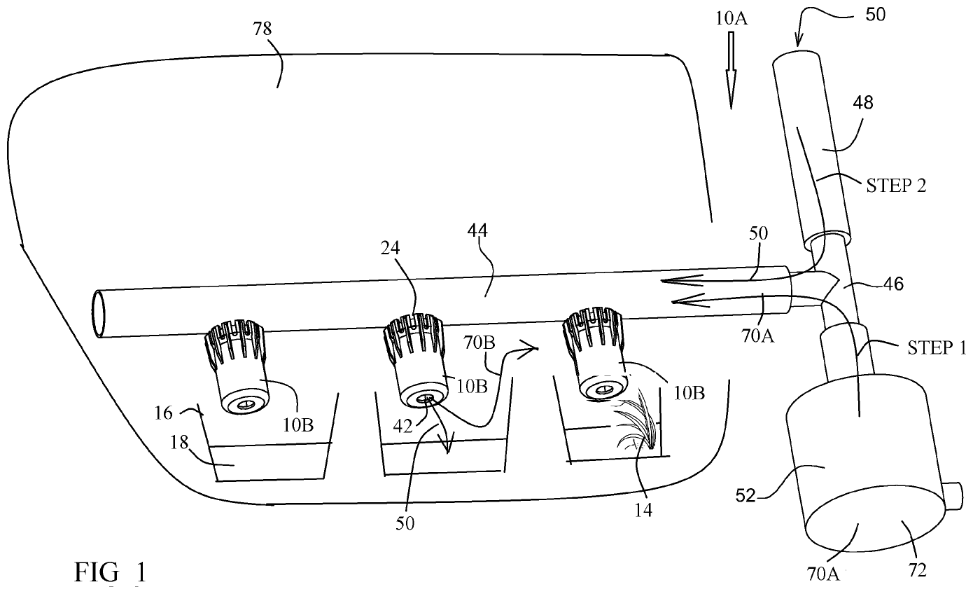

FIG. 1 depicts an air freshening system according to one embodiment of the invention.

An air freshening system 10A according to one embodiment of the invention, includes a central air inlet 72 and an air compressor 52, for flowing air 70A from outside a room 78 or from inside room 78 for circulating the air within room 78; a central water inlet 48, for flowing water 50; a central pipe 44 branched to central air compressor 52 and to central water inlet 48; and a plurality of air-freshening devices 10B, according to invention, each communicating with central pipe 44.

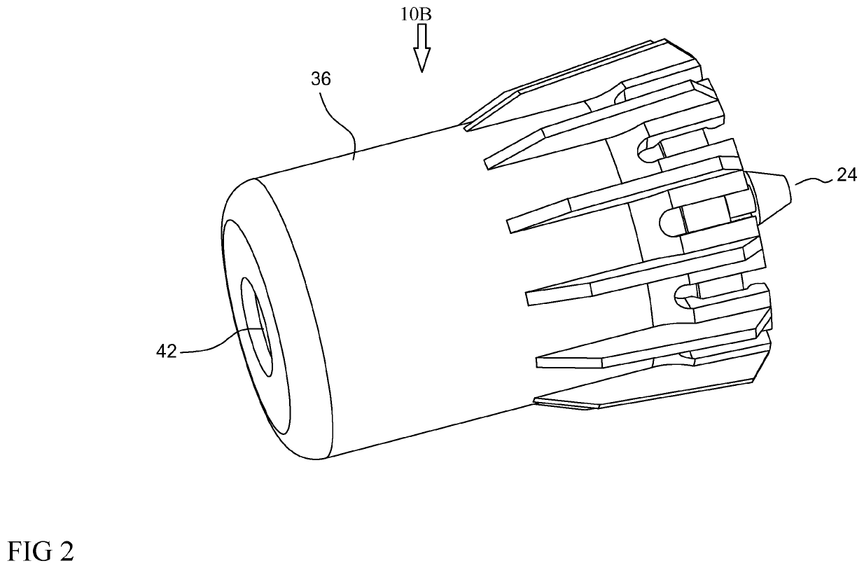

FIG. 2 depicts one of the water drippers of FIG. 1.

Air-freshening device 10B includes an inlet 24 and an outlet 42.

Referring again to FIG. 1, inlet 24 of air-freshening device 10B communicates with central pipe 44.

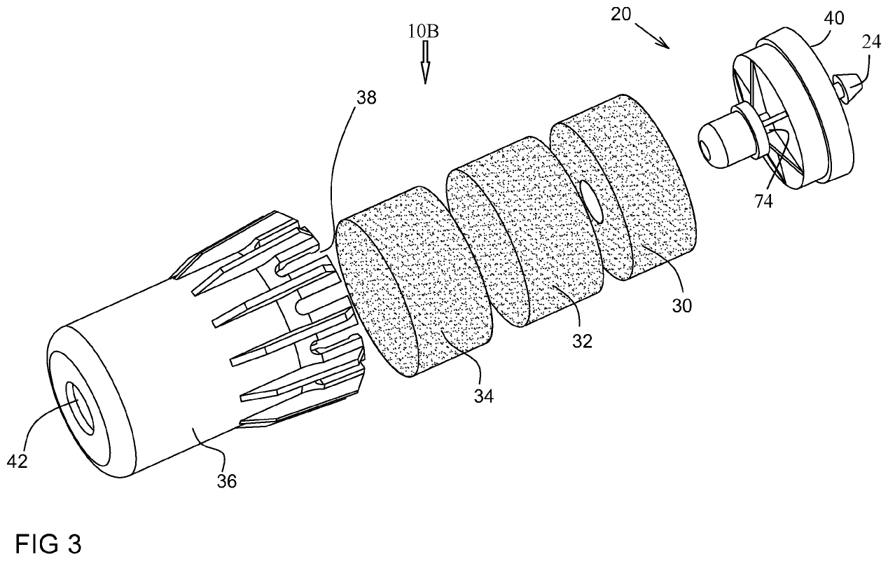

FIG. 3A is an exploded view of the water dripper of FIG. 2.

The term “water dripper” refers herein to a prior art device for providing slow supply of water, for drip irrigation.

Air-freshening device 10B further includes a water dripper 20, including inlet 24 and an outlet 74.

Air-freshening device 10B further includes a filter 30, and a packaging 36, for directing the air and the water from water dripper outlet 74, through filter 30, to outlet 42 of device 10B.

Referring again to FIG. 1, at the first step, air compressor 52 flows air 70A, through filter 30 (shown in FIG. 3), to outlet 42, for supplying filtered air 70B into room 78 or therewithin in a closed loop; and at the second step, compressor 52 ceases, and central water inlet 48 supplies water, for cleaning filter 30 (shown in FIG. 3).

Referring yet to FIG. 1, preferably, water 50 drops into a container 16, which may contain a plant 14, for utilizing the water supply, for irrigating the plant.

After a short cleaning of filter 30, the first and second steps repeat.

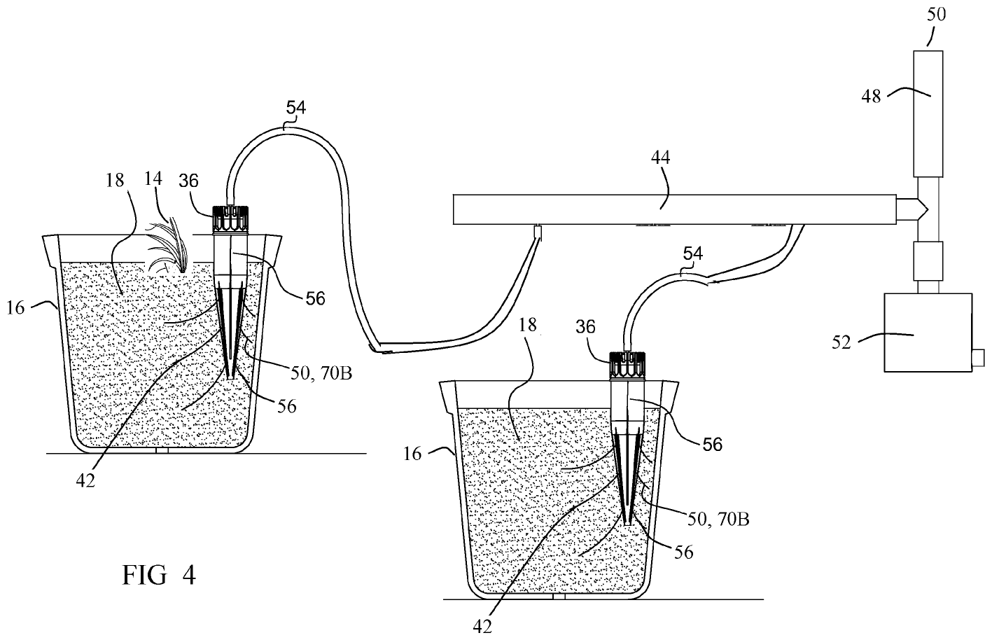

FIG. 4 depicts the air freshening system of FIG. 1, for freshening the ground of a plant.

According to this embodiment, air-freshening device 10B includes a pipe 54 extending from central pipe 44; and a stake 56, being part of the piping, for inserting thereof into the ground. Thus, the filtered air 70B is supplied to ground 18.

Plant 14 and filter 30 (shown in FIG. 3) together provide improved cleaning, for the ground and for the filter. The roots of plant 14 include probiotics (microorganisms providing health benefits when consurned) capable of cleaning filter 30.

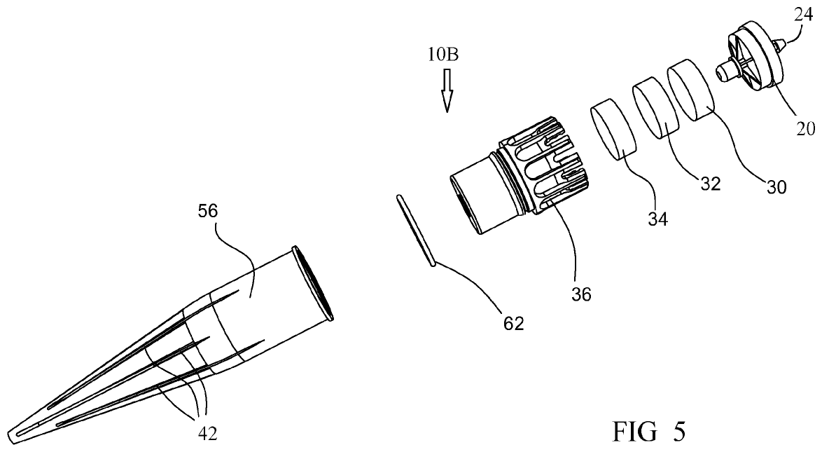

FIG. 5 is an exploded view of the air freshening device of FIG. 4.

In order that a plant will not cover a significant portion of outlet 42, outlet 42 is elongated.

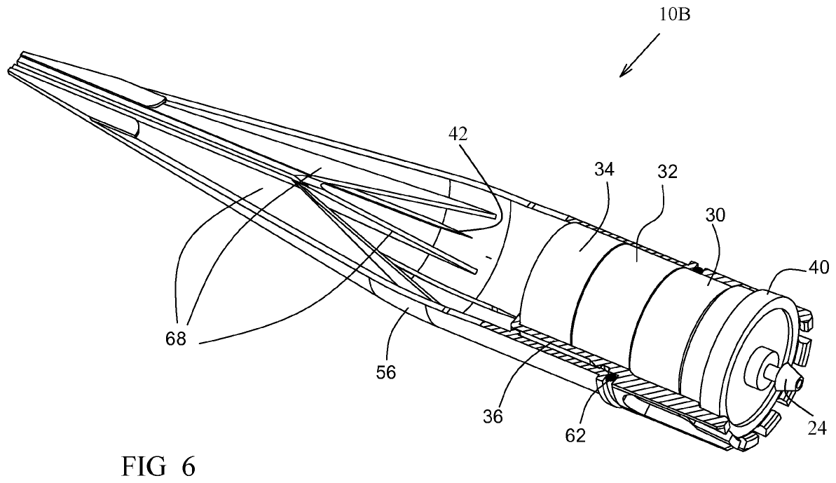

FIG. 6 is a cut view of the air freshening device of FIG. 4.

Partitions 68 between adjacent 42 provide physical strength for the tacking operation.

Thus, in one aspect, the invention is directed to an air freshening system (10A), including:
an air compressor (52), for flowing air (70);
a water inlet (48), for supplying water (50);
a central pipe (44), for receiving the air (70) from the air compressor (52), and for receiving the water (50) from the water inlet (48); and
a plurality of end devices (10B), each including:
a) a water dripper (20), including an inlet (24), for communicating with the central pipe (44):
b) a filter (30), for filtering the air (70): and
c) an outlet (42), for supplying filtered air (70B), thereby allowing cleaning the filters (30) of the plurality of end devices (10B) by supplying the water (50) thereto.

The water (50) may further be supplied for irrigation.

The air freshening system (10A) may further include:
plants (14), for further cleaning the filters (30).

Thus, plants 14 clean filters 30 via biologic effects, and filters 30 provide clean air to plants 14. Thus, one contributes to the other.

The filtered air (70B) may be is supplied for room air freshening or for air freshening to the ground (18).

In another aspect, the invention is directed to an air freshening device (10B), including:
a water dripper (20), including an inlet (24), for supplying water (50) and air (70A);
a filter (30), for filtering the flowed air (70A); and
an outlet (42), for supplying filtered air (70B), thereby allowing cleaning the filter (30) by supplying water (50) thereto.

The air freshening device (10B) may further include:
a packaging (36), for directing the flowed air (70A) and the supplied water (50) from an outlet (74) of the water dripper (20), through the filter (30), to the outlet (42) of the air freshening device (10B).

The air freshening device (10B) may further include:
a stake (56), including the outlet (42), thereby upon inserting the stake (56) into the ground (18), supplying the filtered air (70B) thereto.

In the figures and/or description herein, the following reference numerals (Reference Signs List) have been mentioned:
numeral 10A denotes the air freshening system, according to one embodiment of the invention;
numeral 10B denotes the air freshening device, according to one embodiment of the invention;
numeral 14 denotes a plant;
numeral 16 denotes a container;
numeral 18 denotes ground contained in the container;
numeral 24 denotes the inlet of the air freshening device and of the water dripper;
numerals 30, 32, and 34 denote filters;
numeral 36 denotes the packaging;
numeral 38 denotes a springy leaf, for fastening the packaging to the water dripper;
numeral 40 denotes the water circulation space, for slowing the water flow;
numeral 42 denotes the outlet of the air freshening device;
numeral 44 denotes the central pipe;
numeral 46 denotes a piping branch;
numeral 48 denotes a water inlet;
numeral 50 denotes supplied water;
numeral 52 denotes the air compressor;
numeral 54 denotes a pipe;
numeral 56 denotes a stake, constituting a pipe;
numeral 62 denotes a sealing ring;
numeral 68 denotes a partition;
numeral 70A denotes the flowed air;
numeral 70B denotes the filtered air;
numeral 72 denotes the central air inlet;
numeral 74 denotes the outlet of the water dripper; and
numeral 78 denotes the room.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. An air freshening system, comprising:
an air compressor, for flowing air;
a water inlet, for supplying water;
a central pipe, for receiving said air from said air compressor, and for receiving said water from said water inlet; and
a plurality of end devices, each comprising:
a) a water dripper, comprising an inlet, for communicating with said central pipe
b) a filter, for filtering said air; and
c) an outlet, for supplying filtered air,
thereby allowing cleaning said filters of said plurality of end devices by supplying said water thereto.

2. An air freshening system according to claim 1, wherein said water is further supplied for plant irrigation.

3. An air freshening system according to claim 1, further comprising:
plants, for further cleaning said filters.

4. An air freshening system according to claim 1,
wherein said filtered air is supplied for a member selected from a group consisting of. room air freshening, air freshening to a ground.

5. An air freshening device, comprising:
a water dripper, comprising an inlet, for supplying water and air;
a filter, for filtering said supplied air; and
an outlet, for supplying filtered air,
thereby allowing cleaning said filter by supplying water thereto.

6. An air freshening device according to claim 5, further comprising:
a packaging, for directing said supplied air and said supplied water from an outlet of said water dripper, through said filter to said outlet of said air freshening device.

7. An air freshening device according to claim 5, further comprising:
a stake, comprising said outlet,
thereby upon inserting said stake into a ground, supplying said filtered air thereto.
